(19) United States
(12) Patent Application Publication
(10) Pub. No.: US 2009/0138614 A1
(43) Pub. Date: May 28, 2009

(54) METHOD AND APPARATUS FOR STREAMING MEDIA IN A COMMUNICATION NETWORK

(75) Inventors: Daniel R. Tayloe, Phoenix, AZ (US); Chih-Ming J. Chiang, Chandler, AZ (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/946,070

(22) Filed: Nov. 28, 2007

(51) Int. Cl. G06F 15/16

(52) U.S. Cl. 709/231

(57) ABSTRACT

A method and apparatus for streaming media content in a communication network (100) is provided. The method includes (304) receiving a request from a plurality of client devices at the content server (102). The method also includes (306) initializing the content server-streaming of the media content to the client device by using at least one of the low Quality of Service (QoS) flow and the high QoS flow.

### FIELD OF THE INVENTION

The present invention pertains to streaming media in a communication network, and more particularly, to congestion management and fast start-up of streaming media.

### BACKGROUND

A communication network comprises a plurality of communicating devices that are connected to each other for the purpose of sharing media content. The communicating devices include at least one client device for sending a request for media content and at least one server device for transmitting the media content to a client device. In recent times, advancements in the field of transmitting media content have been directed towards reducing the lead time associated with the sharing of media content between communicating devices in a communication network. The communicating devices can share information in the communication network by downloading or streaming the information.

Downloading media content over communication networks is a slow way of sharing media content. Users cannot access the media content until the complete content is downloaded, whereas in streaming media content, users can access the media content while it is being downloaded. The lead time taken to download the media content is the time required to completely download it, whereas in streaming, the lead time is the time required to download the initial play-out buffer. The initial play-out buffer constitutes a small part of the actual media content. Hence, the delay associated with the streaming process is less as compared to the downloading process. When the media content is streamed at the client device, the entire data may not be downloaded and could be reproduced in real time in the course of buffering. In other words, a user's device streams media as it is received from the content server, rather than waiting for an entire file to be downloaded.

The content server transmits the media content to the client device. The media content is streamed to the client device on a real-time basis when the content server and the client device are connected over a wired/wireless network.

The main drawback of the present streaming system is the long lead time for users who wish to access the media content after making a request to the content server to play it. A streaming system is judged on its efficiency on the basis of the time taken between the user making a request for the media content and the actual playing of the media content. The long lead time implies the initial play-out buffer of the media stream is downloaded at a low data rate. Therefore, there is a need to download the initial play-out buffer at a faster data rate. A reduction in the lead time will make the system more efficient and user-friendly.

Another drawback of the streaming system is that only a low Quality of Service (QoS) flow or a high QoS flow is used during media streaming. The low QoS flow enables a high buffering speed but the quality of the media stream is compromised for fast downloading of the play-out buffer, whereas the high QoS flow provides a low buffering speed but the high quality of the media content is maintained. Another drawback of the streaming system is the lack of admission control in the communication network. Admission control enables the network to accept or reject a new request for media content, depending on the available bandwidth. Therefore, there is a need to implement admission control in the streaming environment to control the traffic entering the network and manage network congestion without affecting on-going applications at the client device.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate the embodiments and explain various principles and advantages, in accordance with the present invention.

FIG. 1 illustrates a communication network, in which various embodiments of the present invention can be practiced;

FIG. 2 is a block diagram illustrating a content server, in accordance with various embodiments of the present invention;

FIG. 3 is a flow diagram illustrating a method for streaming media content in a communication network, in accordance with some embodiments of the present invention;

FIG. 4 is another flow diagram illustrating another method for streaming media content in a communication network, in accordance with an embodiment of the present invention; and

FIGS. 5 and 6 are flow diagrams illustrating yet another method for streaming media content in a communication network, in accordance with some embodiments of the present invention.

Skilled artisans will appreciate that elements in the figures are illustrated for simplicity and clarity and have not necessarily been drawn to scale. For example, the dimensions of some of the elements in the figures may be exaggerated, relative to other elements, to help to improve understanding of the embodiments of the present invention.

### DETAILED DESCRIPTION

Before describing in detail embodiments that are in accordance with the present invention, it should be observed that the embodiments reside primarily in combinations of method steps and apparatus components related to streaming media in a communication network. Accordingly, the apparatus components and method steps have been represented, where appropriate, by conventional symbols in the drawings, showing only those specific details that are pertinent for an understanding of the embodiments of the present invention, so as not to obscure the disclosure with details that will be readily apparent to those with ordinary skill in the art, having the benefit of the description herein.

In this document, relational terms such as first and second, top and bottom, and the like, may be used solely to distinguish one entity or action from another entity or action, without necessarily requiring or implying any actual relationship or order between such entities or actions. The terms ‘comprises,’ ‘comprising,’ or any other variation thereof, are intended to cover a non-exclusive inclusion, such that a process, method, article or apparatus that comprises a list of elements does not include only those elements but may include other elements not expressly listed or inherent to such a process, method, article or apparatus. An element proceeded by ‘comprises . . . a’ does not, without more constraints, preclude the existence of additional identical elements in the process, method, article or apparatus that comprises the element.

A method for streaming media content from a content server to a client device in a communication network is provided. The method includes receiving a request for the media content at the content server from the client device. Further, the method includes initializing streaming media content from the content server to the client device by using at least one of a low Quality of Service (QoS) flow and a high QoS flow. The low QoS flow provides a relatively high buffering speed and the high QoS flow provides a relatively low buffering speed.

A method for streaming media content from a content server to a client device in a communication network is provided. The method includes receiving a request for the media content from the client device at the content server. Further, the method includes providing a low Quality of Service (QoS) flow to initialize streaming of the media content at the client device. The low QoS flow captures a play-out buffer of the media content and provides a relatively high initial buffering speed and maximum utilization of available bandwidth. Furthermore, the method includes switching from the low QoS flow to a high QoS flow after the play-out buffer is captured. The high QoS flow provides a relatively low buffering speed and utilizes a predefined minimum bandwidth.

A content server for providing media content streaming to a client device in a communication network is provided. The content server includes a network interface for receiving a request for the media content at the content server. The content server includes a processing unit that is communicatively coupled to the network interface. The processing unit is adapted to initialize streaming of media content to the client device by using at least one of the low Quality of Service (QoS) flow and the high QoS flow. The low QoS flow provides a relatively high buffering speed and the high QoS flow provides a relatively low buffering speed.

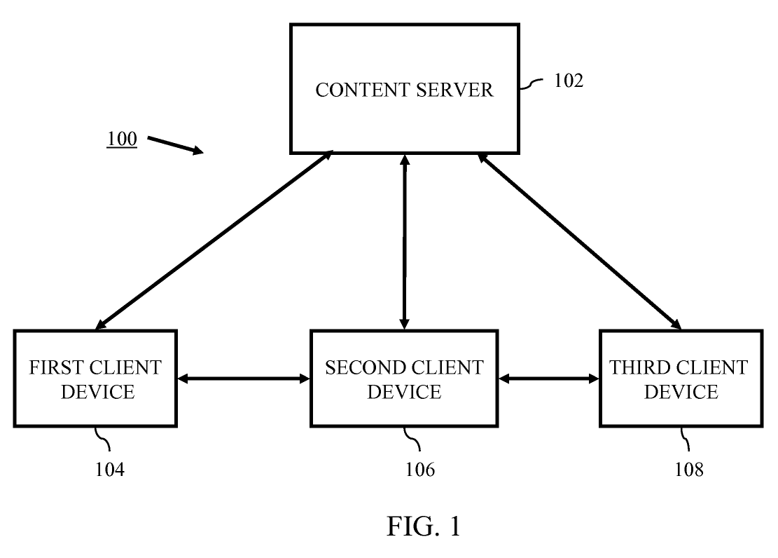

FIG. 1 illustrates a communication network 100, in which various embodiments of the present invention can be practiced. The communication network 100 can be classified on the basis of the network layer, the scale or extent of reach of the network, the connection method used to connect the individual devices in the network, the functional relationship between the elements of the network, the network topologies, the service provided and the protocol. The communication network 100 comprises a plurality of client devices that are connected to each other to share media content. The client devices communicate over the communication network 100 by using a communication medium over which the media content is transmitted. The communication medium can be a wired or wireless medium. Examples of the communication network 100 include, but are not limited to, IEEE 802.16-based broadband wireless access networks, Advanced Mobile Phone Systems (AMPS) networks, Global System for Mobile Communications (GSM) networks, Digital Cellular Systems (DCS) networks, Universal Mobile Telecommunications Systems (UMTS) networks, Code Divisional Multiple Access (CDMA) networks, Code Divisional Multiple Access Evolution-Data Optimized (CDMA EV-DO) networks, Ultra Mobile Broadband (UMB) networks, Long Term Evolution (LTE) networks, Local Area Networks (LANs), Metropolitan Area Networks (MANs) and Wide Area Networks (WANs).

The communicating devices in the communication network 100 include at least one client device and at least one content server 102. These client devices can be selected from a first client device 104, a second client device 106 or a third client device 108. Examples of such client devices include, but are not limited to, cellular phones, Internet Protocol Televisions (IPTVs), Voice-over-Internet Protocol (VoIP), computers, laptops, Personal Digital Assistants (PDAs), High-Definition Televisions (HDTVs) and Set-top Boxes (STBs).

The client device, e.g., first client device 104 in a communication network 100, makes a request for the media content. After receiving this request, the content server 102 starts streaming the media content on the first client device 104. The streaming process enables the transmission of the media content in real time. Examples of the media content include, but are not limited to, data, information, video, audio, text or any combination thereof. By streaming the media content, users can access it before downloading it completely.

The streaming process needs a high-speed start-up rate to load the initial play-out buffer and a low rate to keep up with a play-out rate. Buffering is a phenomenon which occurs when a streaming media player is saving portions of a streaming media file to local storage for playback. Most streaming media players buffer a small percentage of media content, for example 5-10% of media content, before beginning to play it. Buffering may also occur in the midst of playing the media content, when the available bandwidth does not match the required bandwidth of the presentation. The play-out buffer is a storage medium that is used to compensate for the difference in the rate of data flow or the time of occurrence of events while transferring data from one device to another. The play-out buffer is used for many purposes but is not limited to hold data, for use at a later time; enabling corrections on timing to be made on a data stream; collecting and organizing binary data bits in groups that can be operated as a unit; and delaying the transit time of a signal to enable other operations to occur.

A low Quality of Service (QoS) flow provides a high buffering speed and a high QoS flow provides a low buffering speed. The low QoS flow is capable of providing high buffering speed only if the bandwidth is available in the communication network 100. The media content can be streamed by using either the low Quality of Service (QoS) flow or the high QoS flow or both. When both, the low QoS flow and the high QoS flow, are active in the communication network 100, all the bandwidth available in the communication network 100 is used. The QoS flow/flows associated with the streaming process depends on the congestion in the communication network 100. The low QoS flow utilizes the maximum bandwidth available in the communication network 100, to quickly stream the media content. The low QoS flow provides a relatively high buffering speed, as compared to the buffering speed of the high QoS flow. The low QoS flow enables a high buffering speed only if excess bandwidth is available in the network. The low QoS flow can be called a best effort flow since it has zero assigned bandwidth and is allowed to make use of any excess bandwidth available in the communication network 100. The excess bandwidth is the bandwidth available in the communication network 100 after allocating bandwidth to the high QoS flow. The high QoS flow guarantees a predefined minimum bandwidth to maintain the play-out rate. Further, as compared to the low QoS flow, the high QoS flow has a relatively low buffering speed.

For one of the embodiments of the invention, both the low QoS flow and the high QoS flow can be active in the communication network 100. In this case, if the communication network 100 is congested, then the low QoS flow will get starved, leaving the high QoS flow to capture the play-out buffer. The high QoS flow will capture the play-out buffer slowly as compared to the low QoS flow. On the other hand, if the communication network 100 is not congested then both the low QoS flow and the high QoS flow are utilized together to capture the play-out buffer. When both the low QoS flow and the high QoS flow are utilized, then the play-out buffer is captured at a much higher speed as compared to when only one of the two QoS flows is being used. Thus, when both the flows capture the initial play out buffer, all the bandwidth available in the communication network 100 is used. Optionally, after the initial play-out buffer is captured, the low QoS flow can either be dropped or simply left unused.

FIG. 1 also shows the first client device 104, the second client device 106 and the third client device 108. The first client device 104 can exchange media content with the content server 102 over the communication network 100. The first client device 104 makes a request for the media content to the content server 102, which acts as a database for the media content of the client devices. After receiving the request, the content server 102 can accept, process and return the requested information to the first client device 104. The user of the first client device 104 can access the media content after the initial play-out buffer is downloaded, wherein the media content is being streamed from the content server 102.

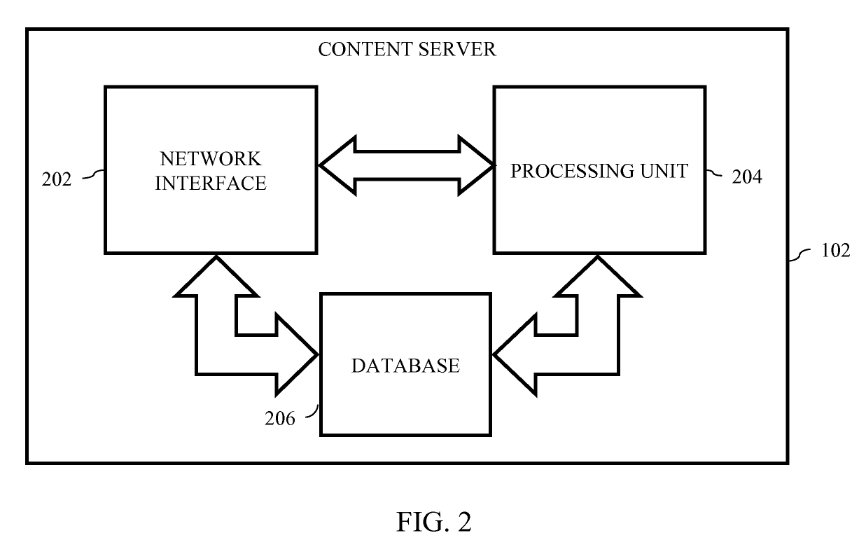

FIG. 2 is a block diagram illustrating the content server 102, in accordance with some embodiments of the present invention. Those skilled in the art will appreciate that the content server 102 may include all, additional or less components than those shown in FIG. 2. The content server 102 acts as a database for the media content of the client devices, wherein media content can be accessed by the client devices over the communication network 100. The content server 102 includes a network interface 202 and a processing unit 204.

The network interface 202 defines the communication boundary between two client devices and is used to connect content server 102 to the communication network 100. Further, the network interface 202 can provide a means of translation between the client devices, so that the client devices can interact freely with each other. The network interface 202 is capable of receiving a request for the media content from one or more of the client devices in the communication network 100. The network interface 202 can handle multiple requests simultaneously from the same or different client devices. The network interface 202 accepts or rejects a request for the media content, depending on the bandwidth available in the communication network 100. The network interface 202 is communicatively coupled to the processing unit 204.

The processing unit 204 is adapted to initialize streaming of the media content to the client device, wherein streaming is initialized by using either the low QoS flow or the high QoS flow or both. Initial streaming of the media content is performed to capture the initial play-out buffer. The media content is not played until the time the play-out buffer of the media content is captured. The processing unit 204 is also adapted to use the high QoS flow to stream the media content after the play-out buffer is captured. The processing unit 204 uses both the high QoS flow and the low QoS flow simultaneously during the initial streaming of the media content if enough bandwidth is available. Further, the processing unit 204 can dynamically switch between either of the two flows during the initial streaming of the media content. The QoS flows can be switched at any time during the initial buffering of the media content, depending on bandwidth requirement in the communication network 100.

Let us consider a scenario in which initial streaming of the media content involves using both the low QoS flow and the high QoS flow. During the initial streaming of the media content, some other application at the client device could require bandwidth that is being used in the initial streaming of the media content. The processing unit 204 then releases bandwidth either by switching to the high QoS flow only or by releasing some part of bandwidth associated with the low QoS flow depending on the bandwidth requirement. The availability of bandwidth depends on the congestion in the communication network 100. The processing unit 204 is also adapted to allocate and de-allocate either the high QoS flow or the low QoS flow or both. The allocation and de-allocation of the QoS flow can be performed dynamically during the streaming of the media content. The allocation and de-allocation of the QoS flow depends on the congestion in the communication network 100.

The processing unit 204 also de-allocates assigned QoS flow(s) if the play-out buffer falls below a predefined minimum value or the play-out buffer gets exhausted during the streaming of the media content. Temporary congestion in the communication network 100 can force the de-allocation of the low QoS flow and even the high QoS flow. The de-allocation of the flow will stop the streaming of the media content. Thereafter, when the congestion in the communication network 100 clears, both the low QoS flow and the high QoS flow will be utilized to resume streaming of the media content and to re-capture the pay-out buffer. In this case, streaming of the media content will resume from the instance, of the media content, that it was stopped. The processing unit 204 then starts the streaming process again by re-allocating either the low QoS flow or the high QoS flow or both. When both the low QoS flow and the high QoS flow are utilized, the play-out buffer is captured at a much higher speed as compared to when only one of the two QoS flows is being used. Thus, when both the flows capture the initial play out buffer, all the bandwidth available in the communication network 100 is used. Optionally, after the initial play-out buffer is captured, the low QoS flow can either be dropped or simply left unused.

For one embodiment of the present invention, the content server 102 can include a database 206 to store the media content. The media content can be accessed by the network interface 202 and processing unit 204 from the database 206. The database 206 can be any memory device, such as Random Access Memory (RAM), a Hard Drive Disk (HDD), a flash memory, or any other storage device known in the art. The database 206 can be operatively coupled to the network interface 202 and the processing unit 204.

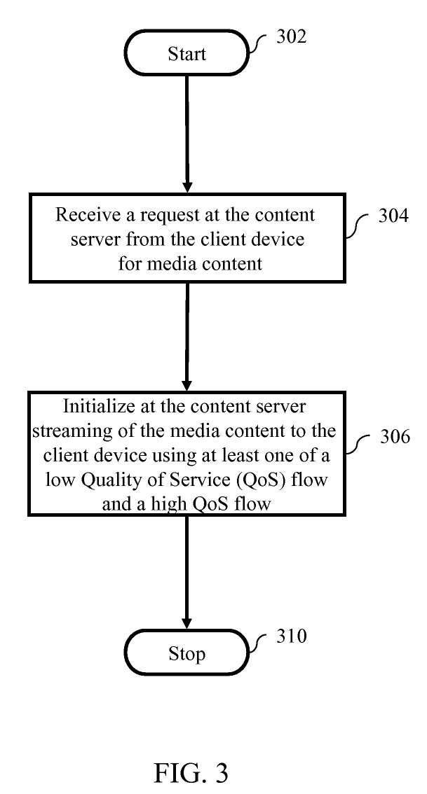

FIG. 3 is a flow diagram illustrating a method for streaming media content in a communication network, in accordance with some embodiments of the present invention. Although the method has been described by using the following steps, it should be apparent to a person skilled in the art that the method could include more or fewer steps. The method for streaming media content at the first client device 104 initiates at step 302. At step 304, the network interface 202 receives a request for the media content. This request is sent by at least one of the client devices. Herein, the request can be transmitted by one or more client devices from the first client device 104, the second client device 106 or the third client device 108.

At step 306, the processing unit 204 initializes streaming of the media content to the first client device 104 by using either the low QoS flow or the high QoS flow or both to capture the play-out buffer; the play-out is captured (or downloaded) at the first client device 104. The low QoS flow utilizes the maximum bandwidth available in the communication network 100 to quickly stream the media content. The high QoS flow guarantees a predefined minimum bandwidth to maintain the play-out rate. The method for streaming media content at the first client device 104 ends at step 310.

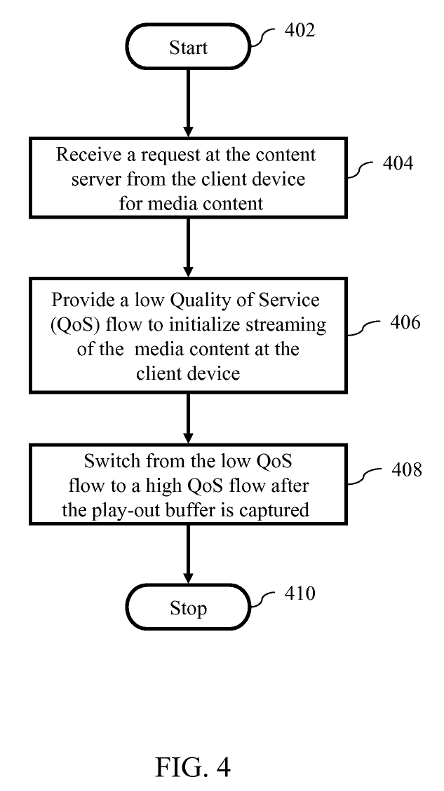

FIG. 4 is another flow diagram illustrating another method for streaming media content in a communication network, in accordance with an embodiment of the present invention. The method for streaming the media content at the first client device 104 initiates at step 402. At step 404, the network interface 202 receives a request for the media content, which is sent by at least one of the client devices. Hence, the request can be checked by one or more client devices from the first client device 104, the second client device 106 or the third client device 108.

At step 406, the processing unit 204 initializes streaming of the media content to the first client device 104 by using the low QoS flow, wherein the low QoS flow is allocated to quickly capture the play-out buffer of the media content. The low QoS flow utilizes the maximum bandwidth available in the communication network 100 to quickly stream the media content. At step 408, the processing unit 204 switches the low QoS flow to the high QoS flow after the play-out buffer is captured. Switching from the low QoS flow to the high QoS flow de-allocates the excess bandwidth assigned to the low QoS flow. The method for streaming media content at the first client device 104 ends at step 410.

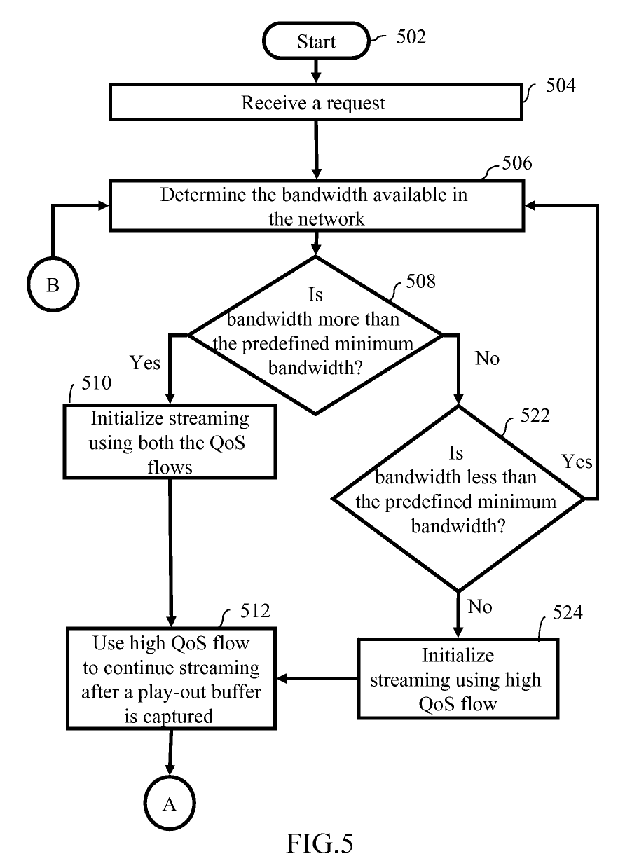

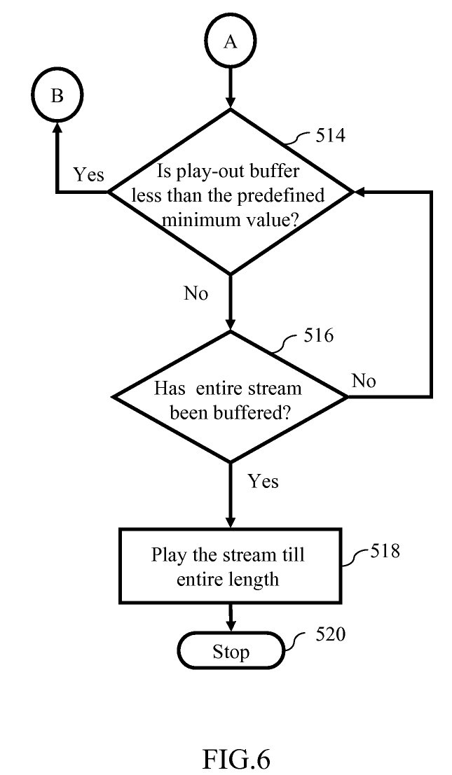

FIGS. 5 and 6 are flow diagrams illustrating another method for streaming media content in a communication network, in accordance with some embodiments of the present invention. The method for streaming media content at the first client device 104 initiates at step 502. At step 504, the network interface 202 receives a request for the media content. The request for the media content is sent by at least one of the client devices. Herein, the client device can be the first client device 104, the second client device 106 or the third client device 108. The first client device 104 communicates with the content server 102 in the communication network 100.

After receiving the request, at step 506, the processing unit 204 determines the bandwidth available in the communication network 100. This bandwidth is also utilized to initialize the process of streaming the media content to the first client device 104. The bandwidth available in the communication network 100 depends on the congestion in the communication network 100, wherein the congestion refers to the utilization of bandwidth available in the communication network 100.

At step 508, the bandwidth available in the communication network 100 is compared to the predefined minimum bandwidth. The predefined minimum bandwidth is the minimum bandwidth required to stream the requested media content to the first client device 104. The predefined minimum bandwidth can vary, depending on the media content being requested. If the bandwidth available in the communication network 100 is more than the predefined minimum bandwidth at step 508, then the processing unit 204 initializes the process of streaming the media content to the first client device 104 at step 510.

The processing unit 204 can initiate streaming of the media content by allocating either the low QoS flow or the high QoS flow or both. Hence, both the low QoS flow and the high QoS flow are used to capture the initial play-out buffer. The selection of the flows or the combination of the flows depends on the bandwidth available in the communication network 100. The low QoS flow utilizes the maximum bandwidth available in the communication network 100 to quickly capture the play-out buffer. The high QoS flow guarantees a predefined minimum bandwidth to maintain the play-out rate. The initial streaming of the media content is carried on until the play-out buffer is captured. The play-out buffer is a storage medium that is used to compensate for the difference in the rate of the data flow or time of occurrence of events while transferring data from one device to another. The play-out buffer is used for many purposes but is not limited to holding data for use at a later time, enabling timing corrections to be made on a data stream, collecting and organizing binary data bits into groups that can then be operated as a unit and delay the transit time of a signal to enable other operations to occur.

After the play-out buffer is captured, then at step 512 the processing unit 204 uses the high QoS flow to continue the process of streaming the media content. The processing unit 204 uses a two-way switch to switch between the two flows. Switching to the high QoS flow de-allocates the excess bandwidth assigned to the low QoS flow. Hence, the excess bandwidth is made available to other applications in the communication network 100. De-allocation of the excess bandwidth results the low QoS flow with zero assigned bandwidth but the low QoS flow is allowed to make use of any excess bandwidth available in the communication network 100 to stream the media content whenever required.

At step 514, the processing unit 204 constantly monitors the play-out buffer that has been captured during the streaming of the media content. If the play-out buffer is more then the predefined minimum value, then at step 516, the processing unit 204 checks whether the entire media stream has been buffered or not. If the entire media stream has been buffered then the media stream is played for the entire length. The method for streaming media content at the first client device 104 ends at step 520. However, at step 516, if the entire media stream has not been buffered then the method goes to step 514. Further, if at step 514, the play-out buffer is less then the predefined minimum value, then the method goes to step 506, then the processing unit 204 again determines the bandwidth available in the communication network 100.

If at step 508, the bandwidth available in the communication network 100 is less than or equal to the predefined minimum bandwidth then at step 522 the processing unit 204 determines which of the two conditions is true, i.e., the bandwidth available in the communication network 100 is equal to the predefined bandwidth or less than the predefined bandwidth. If at step 522, the bandwidth available in the communication network 100 is less than the predefined minimum bandwidth then the method goes to step 506. However, if the bandwidth available in the communication network 100 is equal to the predefined minimum bandwidth at step 522, then the processing unit 204 initializes the streaming of the media content by using the high QoS flow at step 524. The initial streaming of the media content by using the high QoS flow is carried on until the play-out buffer is captured at step 510. After the play-out buffer is captured, at step 512, the processing unit 204 uses the high QoS flow to continue the process of streaming the media content. The bandwidth is determined to re-capture the play-out buffer using both the flows.

At step 510, the processing unit 204 uses both the low QoS flow and the high QoS flow. The two flows are used together to utilize the excess bandwidth available in the communication network 100, so that the play-out buffer can be re-captured as quickly as possible. The re-capturing of the play-out buffer does not disturb the on-going streaming process of the media content. After the play-out buffer is re-captured, the sequence of steps, starting from step 512, is followed in the pattern mentioned above.

Various embodiments of the present invention have significant advantages. The present invention provides a method and apparatus for streaming media in a communication network. For some embodiments of the present invention, both the high QoS flow and the low QoS flow are active during initial buffering. The low QoS flow provides high buffering speed to capture the play-out buffer. The high QoS flow guarantees the minimum bandwidth required to sustain the play-out rate. In some embodiments of the present invention, the communication network provides a high buffering speed when the communication network is the least congested and the best capacity when the communication network is congested. In certain embodiments of the present invention, streaming of media content is carried out in real-time.

In the foregoing specification, specific embodiments of the present invention have been described. However, one with ordinary skill in the art will appreciate that various modifications and changes can be made without departing from the scope of the present invention, as set forth in the claims. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage or solution to occur or become more pronounced are not to be construed as critical, required or essential features or elements of any or all the claims. The invention is defined solely by the appended claims, including any amendments made during the pendency of this application and all equivalents of the claims, as issued.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment to streamline the disclosure. This method of disclosure is not to be interpreted as reflecting an intention that the claimed embodiments require more features than are expressly recited in each claim. Rather, as the following claims reflect, the inventive subject matter lies in less than all the features of a single disclosed embodiment. Thus, the following claims are hereby incorporated into the Detailed Description, with each claim standing on its own as a separately claimed subject matter.

What is claimed is:

1. A method for streaming media content from a content server to a client device in a communication network, the method comprising:
receiving a request at the content server from the client device for media content; and
initializing at the content server streaming of the media content to the client device using at least one of a low Quality of Service (QoS) flow and a high QoS flow, wherein the low QoS flow provides a relatively high buffering speed and the high QoS flow provides a relatively low buffering speed.

2. The method as recited in claim 1, further comprising using the high QoS flow at the content server after a play-out buffer is captured.

3. The method as recited in claim 1, wherein the low QoS flow utilizes maximum available bandwidth in the communication network to stream the media content to the client device.

4. The method as recited in claim 1, wherein the high QoS flow utilizes a predefined minimum bandwidth to stream the media content to the client device.

5. The method as recited in claim 4, wherein the predefined minimum bandwidth is necessary for maintaining a play-out rate for streaming the media content to the client device.

6. The method as recited in claim 4, wherein maximum available bandwidth is more than the predefined minimum bandwidth.

7. The method as recited in claim 6, wherein the maximum available bandwidth depends on congestion in the communication network.

8. The method as recited in claim 1, wherein switching from the low QoS flow to the high QoS flow comprises de-allocating the excess bandwidth assigned to the low QoS flow.

9. The method as recited in claim 1, wherein switching from the high QoS flow to the low QoS flow comprises utilizing excess available bandwidth in the communication network.

10. The method as recited in claim 1, wherein the at least one of the high QoS flow and the low QoS flow is de-allocated when the play-out buffer is less than a predefined minimum value anytime during streaming of the media content.

11. The method as recited in claim 10, wherein the at least one of the high QoS flow and the low QoS flow is dynamically allocated to re-capture the play-out buffer.

12. A method for streaming media content from a content server to a client device in a communication network, the method comprising:
receiving a request at the content server from the client device for media content;
providing a low Quality of Service (QoS) flow to initialize streaming of the media content at the client device, the low QoS flow capturing a play-out buffer of the media content and providing a relatively high initial buffering speed and maximum utilization of available bandwidth; and
switching from the low QoS flow to a high QoS flow after the play-out buffer is captured, wherein the high QoS flow provides a relatively low buffering speed and utilizes a predefined minimum bandwidth.

13. The method as recited in claim 12, wherein the at least one of the high QoS flow and the low QoS flow is de-allocated when the play-out buffer is less than a predefined minimum value anytime during streaming of the media content.

14. A content server for providing media content streaming to a client device in a communication network, the content server comprising:
a network interface for receiving a request at the content server from the client device for media content; and
a processing unit, communicatively coupled to the network interface, adapted to:
initialize streaming of the media content to the client device using at least one of a low Quality of Service (QoS) flow and a high QoS flow, wherein the low QoS flow provides a relatively high buffering speed and the high QoS flow provides a relatively low buffering speed.

15. The processing unit as recited in claim 14, further adapted to use the high QoS flow after a play-out buffer is captured.

16. The content server as recited in claim 14, wherein the low QoS flow utilizes maximum available bandwidth in the communication network to stream the media content at the client device.

17. The content server as recited in claim 14, wherein the high QoS flow utilizes a predefined minimum bandwidth to stream the media content at the client device.

18. The content server as recited in claim 17, wherein the predefined minimum bandwidth is necessary for maintaining a play-out rate for streaming the media content.

19. The content server as recited in claim 14, wherein the available bandwidth depends on congestion in the communication network.

20. The content server as recited in claim 14, wherein the switch is a two-way switch for switching between the two the low QoS flow and the high QoS flow.

21. The content server as recited in claim 14, wherein the processing unit is further adapted to allocate and de-allocate the at least one of the high QoS flow and the low QoS flow dynamically.

22. The content server as recited in claim 21, wherein the processing unit is further adapted to allocate the at least one of the high QoS flow and the low QoS flow when the play-out buffer is less than a predefined minimum value anytime during streaming of the media content.
